(19) United States
(12) Patent Application Publication
(10) Pub. No.: US 2006/0243464 A1
(43) Pub. Date: Nov. 2, 2006

(54) Torque and angular rotation measurement device and method

(75) Inventor: Eric S. Heinz, Memphis, TN (US)

Correspondence Address: FITZPATRICK CELLA HARPER & SCINTO, 30 ROCKEFELLER PLAZA, NEW YORK, NY, 10112, US

(73) Assignee: SDGI HOLDINGS, INC., Wilmington, DE (US)

(21) Appl. No.: 11/117,296

(22) Filed: Apr. 29, 2005

(51) Int. Cl. A01B 63/00

(52) U.S. Cl. 172/322

(57) ABSTRACT

Embodiments of the invention include devices and methods for determining information regarding the distance and/or tensile force between bodies based on the travel of a device rotated between the bodies and the torque applied to rotate the device. In some embodiments, the device and method are useful to determine parameters related to spinal vertebral bodies.

### FIELD OF THE INVENTION

Embodiments of the invention relate generally to a device and method for measuring torque and angular rotation. More specifically, some embodiments relate to a device and method for measuring an annular tension between two anatomical structures, based on torque and angular rotation measurements.

### BACKGROUND OF THE INVENTION

Spinal surgery involves many challenges, since the long-term health and mobility of the patient often depend on the surgeon's technique and precision. One type of spinal surgery involves the removal of the natural disc tissue that is located between adjacent vertebral bodies. Procedures are known in which the natural, damaged disc tissue is replaced with an implant, such as an interbody cage or fusion device, a disc nucleus replacement device, or an artificial disc.

Prior to inserting the implant, the surgeon typically removes a portion or all of the affected disc material (discectomy). Once the natural disc tissue is removed, the space between the vertebrae collapses. Thus, before inserting the implant, the surgeon must spread apart the adjacent vertebrae with a distractor or spreader to recreate the intervertebral disc space. This presents a challenge to the surgeon, since the vertebrae must be separated to an extent sufficient to enable the placement of the implant, without over-distracting or damaging the endplates of the vertebral bodies.

Existing devices and methods for measuring annular tension and degree of distraction are cumbersome and require expensive equipment, and/or are limited in their ability to provide useful information. Thus, there remains a need in the art for devices and methods for measuring annular tension and spacing between vertebrae.

### SUMMARY OF THE INVENTION

As used herein, the term “proximal” refers to a direction of the tool closest to the user and furthest from the patient during use of the tool, while the term “distal” refers to a direction of the tool closest to the patient and furthest from the user during use of the tool.

Embodiments of the invention relate to a tool comprising a frame and an implement having a longitudinal axis. A proximal end of the implement is coupled to the frame for rotation relative to the frame about the longitudinal axis of the implement. A distal end of the implement comprises a working end of the implement and is adapted for insertion between two objects. A driver is coupled to the implement, such that force can be applied by the driver to rotate the implement relative to the frame. A torque measurement device is coupled to the implement for measuring a torque on the implement when force is applied by the driver. An angular measurement device is coupled to the implement to measure an angular rotation of the implement relative to the frame.

Other embodiments of the invention relate to a tool comprising a frame and working means for inserting between two objects to engage the objects. A drive means is coupled to the working means for rotating the working means relative to the frame. A torque measurement means is coupled to the tool for measuring a torque on the working means when force is applied by the drive means. An angular measurement means is coupled to the working means to measure an angular rotation of the working means relative to the frame.

Other embodiments of the invention relate to a method of measuring torque and angular rotation of an implement. The method comprises the steps of inserting a working end of the implement between two objects, rotating the implement, such that the working end of the implement engages and presses against the two objects, measuring a torque applied to the implement in the rotating step, and measuring an angular rotation of the implement in the rotating step.

Still other embodiments of the invention relate to a system. The system comprises a tool for measuring torque applied to, and angular rotation of, an implement of the tool placed between two objects, and outputting signals representative of the torque and the angular rotation. A converter is provided, which receives the signals output from the tool and outputs information about a tension between the two objects and a linear displacement between the two objects, based on the signals received from the tool and based on at least one dimension of a working end of the implement. A display unit is provided, which displays the information output from the converter. The information displayed by the display unit comprises information representative of the tension versus the linear displacement.

A better understanding of these and other features and advantages of the invention may be had by reference to the drawings and to the accompanying description, in which exemplary embodiments of the invention are illustrated and described.

### BRIEF DESCRIPTION OF THE DRAWINGS

FIG. 1 is a front elevation view of one embodiment of a tool according to the invention.

FIG. 2A is a plan view of one implement usable with the tool of FIG. 1.

FIG. 2B is a front elevation view of the implement of FIG. 2A.

FIG. 2C is a cross-sectional view of the implement of FIG. 2A, taken along line 2C-2C in FIG. 2A.

FIG. 3A is a plan view of another implement usable with the tool of FIG. 1.

FIG. 3B is a front elevation view of the implement of FIG. 3A.

FIG. 3C is a cross-sectional view of the implement of FIG. 3A, taken along line 3C-3C in FIG. 3A.

FIG. 4A is a plan view of another implement usable with the tool of FIG. 1.

FIG. 4B is a front elevation view of the implement of FIG. 4A.

FIG. 4C is a cross-sectional view of the implement of FIG. 4A, taken along line 4C-4C in FIG. 4A.

FIG. 5A is a plan view of yet another implement usable with the tool of FIG. 1.

FIG. 5B is a front elevation view of the implement of FIG. 5A.

FIG. 5C is a left side view of the implement of FIG. 5A.

FIG. 6 is a schematic force diagram showing the forces acting on an implement of the tool of FIG. 1 during use.

FIG. 7 is a representative graph of data output from the tool of FIG. 1.

FIG. 8 is a representative graph of date derived from the outputs of the tool of FIG. 1.

Throughout the figures, like or corresponding reference numerals have been used to designate like or corresponding parts.

### DETAILED DESCRIPTION

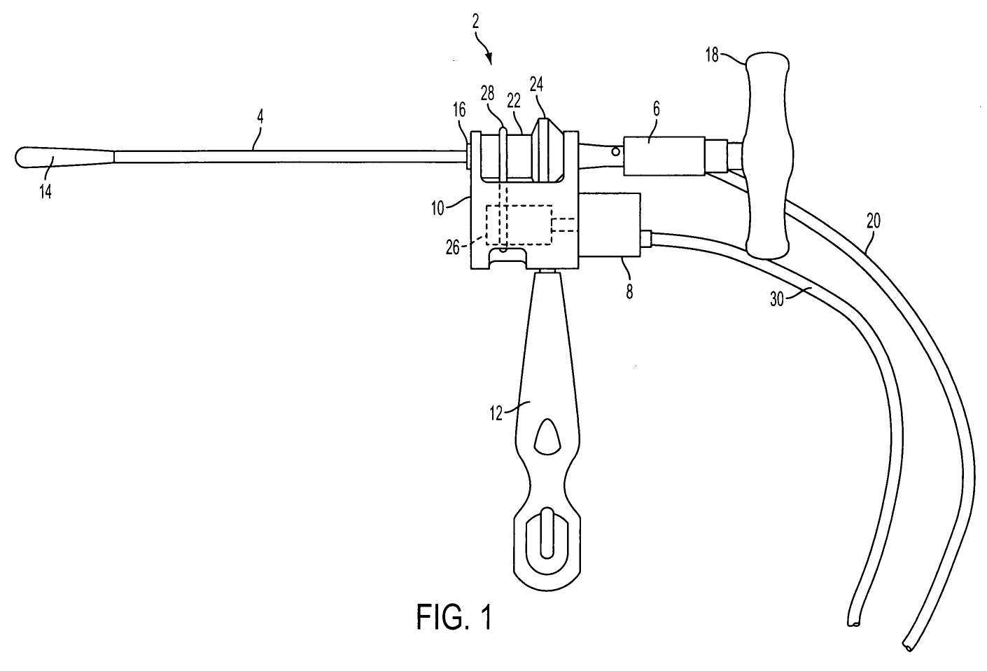

A tool 2 according to one embodiment of the invention is described with reference to FIG. 1. The tool 2 shown in FIG. 1 is designed to measure annular tension between two adjacent vertebrae of a patient. However, tools according to embodiments of the invention can be used to measure tension between any two objects, in both surgical and non-surgical applications. The tool 2 measures tension indirectly by measuring a torque and an angular rotation of an implement 4 inserted between the two objects, as described in more detail below. Accordingly, tools according to embodiments of the invention can also readily be adapted to measure torque versus angular rotation of virtually any object, in both surgical and non-surgical applications (e.g., a threaded fastener, a drive shaft, a spool, and the like).

As shown in FIG. 1, the tool 2 has a generally open frame 10, to which the other components of the tool are coupled. The open configuration of the frame 10 allows it to be easily cleaned between uses. However, the frame 10 may be made in any desired shape and size, depending on the needs of a particular application. A handle 12 extends from the bottom of the frame 10, by which the tool 2 can be held by a surgeon or other user. In the embodiment shown in FIG. 1, the handle 12 extends substantially perpendicularly to the implement 4, when the implement 4 is installed. However, the specifics of the handle 12 are not important, and the handle 12 may be configured in any desirable shape, size, and orientation.

A rotatable connector 22 is disposed in an opening of the frame 10. The connector 22 has a receptacle for receiving a proximal end 16 of the implement 4. The rotatable connector shown in FIG. 1 comprises a conventional Hudson connection that allows the implement 4 to be quickly and easily installed and secured in the tool 2. To remove the implement 4, a user merely has to slide a sleeve 24 toward the front of the tool (left in FIG. 1) and pull the implement 4 away from the frame 10. The implement 4 can be reinstalled by sliding the sleeve 24 toward the front of the tool 2, inserting the proximal end 16 of the implement 4 into the receptacle of connector 22, and releasing the sleeve 24. The sleeve 24 is rearwardly biased so that once released, it will securely hold the implement 4 for rotation relative to the frame 10. Of course, numerous other known connectors may instead be used to releasably secure the implement 4 to the tool 2, such as a square-drive quick-connection, a conventional drill chuck mechanism, a set screw, a tool clamp, a rivet, a snap ring, a press-fit, or the like. Alternatively, the implement 4 may be permanently secured to the tool 2 by, for example, welding, being formed integrally with one or more other components of the tool, or the like.

The implement 4 is coupled to the frame 10 for rotation relative to the frame 10. The implement 4 shown in FIG. 1 has an elongated body, having a proximal end 16 configured to be received and held in the receptacle of the connector 22. A distal end of the implement 4 comprises a working end 14 of the implement 4. The working end 14 may comprise a variety of different configurations, such as a spreader, a shaver, an artificial disc inserter, a socket wrench, a screw driver head, and the like. This allows the tool to be used in a wide variety of surgical procedures. A cross-section of the working end 14 of the implement 4 may have one dimension that is larger than another dimension, though the working end 14 is not limited to this arrangement. Any suitable size and shape of implement may be used with embodiments of the invention, depending on the particular application in which it is to be used.

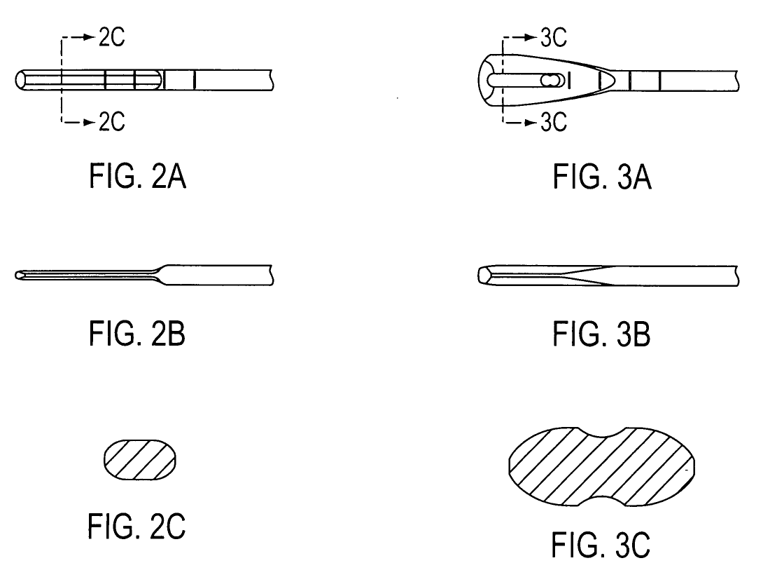

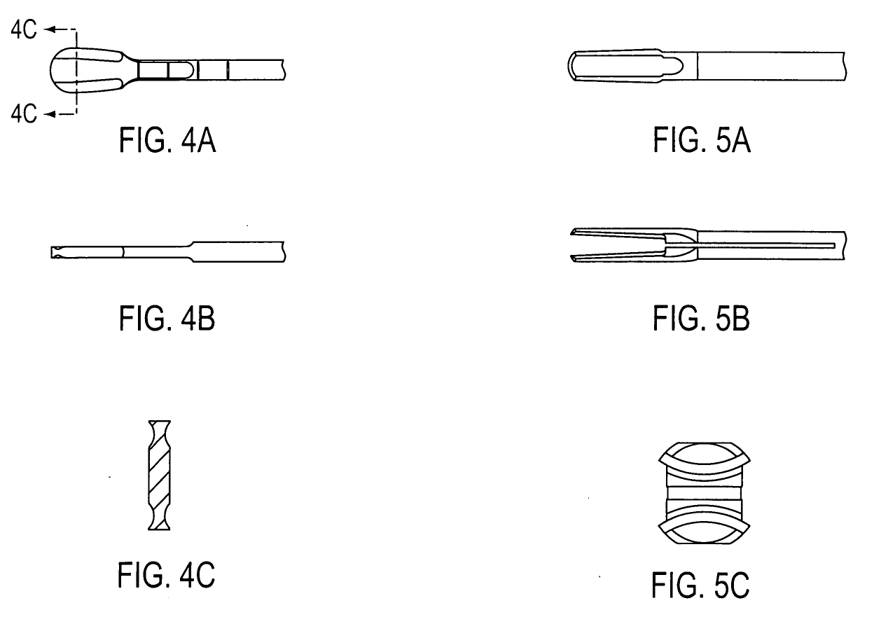

Several implements usable with embodiments of the invention are shown in FIGS. 2A through 2C, 3A through 3C, 4A through 4C, and 5A through 5C, all of which are manufactured by Medtronic Sofamor Danek of Memphis, Tenn. FIGS. 2A through 2C depict a 6-millimeter intervertebral cam spreader. FIGS. 3A through 3C depict a 16×6 degree intervertebral cam spreader. FIGS. 4A through 4C depict a 14-millimeter intervertebral shaver. FIGS. 5A through 5C depict a 9-millimeter medium artificial disc inserter shaft.

Referring again to FIG. 1, a driver 18 is coupled to the implement 4 via the connector 22. As shown in FIG. 1, the driver 18 comprises a T-shaped lever attached to the connector 22 perpendicularly to the implement 4, by which a user can apply a force to rotate the implement 4. Alternatively, the driver 18 could be configured in any other suitable shape that can be easily grasped and rotated by a user. In another alternative, instead of a lever, the driver 18 could be configured as a motor, such as an electric stepper motor. In that case, the motor could be regulatable to limit the force that can be applied by the motor so as not to exceed a set force.

The implement 4 may be provided with a key (not shown), which engages a keyway (also not shown) in the connector 22, so that the implement can only be installed in a certain orientation relative to the driver 18. However, the implement is not limited to this configuration, and in some embodiments the implement may be inserted in any orientation relative to the driver.

A torque measurement device 6 is interposed between the connector 22 and the driver 18, so as to measure a torque applied to the implement 4 by the driver 18. In the embodiment shown in FIG. 1, the torque measurement device comprises a torque cell that outputs an electrical signal indicative of the measured torque. One exemplary torque cell that can be used with embodiments of the invention is a reaction-type, bidirectional torque cell, such as the SWS-20, manufactured by Transducer Technologies of Temecula, Calif. However, any other torque cell, or other suitable torque measurement device may be used with embodiments of the invention. In one alternative, the torque measurement device may simply comprise a twistable torque member having an indicator needle that indicates the torque applied to the torque member on a graduated dial, such as is commonly used in conventional torque wrenches.

An angular rotation measurement device 8 is attached to the frame 10 and is coupled to the connector 22 to measure an angular rotation of the implement 4 and connector 22 relative to the frame 10. In the embodiment shown in FIG. 1, the angular rotation measurement device 8 comprises a rotary encoder that outputs a signal indicative of the measured angular rotation. One suitable rotary encoder usable with embodiments of the invention is an E6A2-CS3C incremental rotary encoder, manufactured by Omron Electronics LLC of Schaumburg, Ill. As shown in FIG. 1, a shaft of the angular rotation measurement device 8 can be fixed to a spool 26, which is housed in the frame 10. The spool 26 can be coupled to the connector 22 by a drive belt 28, in the form of a continuous, flexible band, belt, o-ring, or the like. As shown in FIG. 1, the spool 26 and the connector 22 comprise cylindrical bodies of substantially the same diameter. Thus, as the connector 22 and implement 4 are rotated through a given angle of rotation, the spool 26 is rotated by the drive belt 28 through substantially the same angle of rotation. Of course, numerous other ways of connecting the angular measurement device 8 for rotation in synchronism with the implement 4 will be apparent to one of ordinary skill in the art. For example, instead of the spool and drive belt, the angular measurement device 8 could be driven by one or more gears meshing with one or more gears on the connector 22.

In addition, various other rotary encoders, or other angular rotation measurement devices can be used with embodiments of the invention. For example, an optical rotary encoder may be used, which detects rotation by detecting markings around the exterior of the connector 22 or the implement 4 with an optical detector (such markings could be applied to the connector 22 or implement 4 by painting, etching, application of one or more adhesive labels with the markings thereon, or the like). In another alternative, the angular rotation measurement device 8 could be constructed as a rotary encoder formed integrally with the frame 10, such that the rotary encoder in the frame 10 would detect rotation of the implement 4 or the connector 22 directly. In another example, an angular rotation measurement device according to some embodiments of the invention may be as simple as an arrow on the implement 4 or connector 22 which points to a series of angle markings (e.g., from 0 to 360 degress) on the frame encircling the implement or connector 22. In a variation of that example, a rotatable ring (not shown) having the angle markings thereon could be provided on the frame, so that the angular reference frame could be set, depending on the orientation of the tool prior to measurement.

The components of the tool 2 can be made out of any material conventionally used in medical instruments. The various components of the tool 2 may be reusable or disposable. In one embodiment, the implement 4 is disposable, while the other components are reusable. Non-electrical components of the device that are designed to be reusable may be made of stainless steel, titanium, or other materials conventionally used for surgical instruments. Reusable electrical components may be housed in hermetically sealed housings. Components of the device that are designed to be disposable may be made of plastic. In some embodiments, at least the implement is sterilized, while in some embodiments each component is sterilized, while in still other embodiments none of the components need be sterilized.

When a torque cell 6 and rotary encoder 8 are used, as in the embodiment shown in FIG. 1, the signals output from the torque cell 6 and rotary encoder 8 are transmitted to display and/or conversion units (not shown). In the embodiment shown in FIG. 1, the signals are transmitted via electrical cords 20 and 30, respectively. However, it should be understood that the signals could be transmitted wirelessly by radio frequency, infrared, or other communication means. Suitable transmitters, receivers, and other hardware necessary to implement such wireless operation of the tool would be readily apparent to one of ordinary skill in the art and will, therefore, not be described further herein.

The signals output from the torque cell 6 and rotary encoder 8 may be transmitted via cables 20 and 30 (or wirelessly) to a conventional data acquisition board connected to a personal computer or other processor for conversion and/or to a display unit for display of the signals. The signals may be displayed directly, without significant conversion, as a graph of torque versus angular rotation and/or may be converted to other information, such as annular tension, displacement between two objects, and the like, as described in more detail below. The data acquisition board may include a processor capable of making the conversions onboard, or the computer may carry out the conversions. Alternatively, an integrated display and conversion unit having both a processor and a display screen may carry out these functions. In another alternative, the conversion could be carried out by a preprogrammed integrated circuit. Of course, other types of display and/or conversion units can be used with embodiments of the invention.

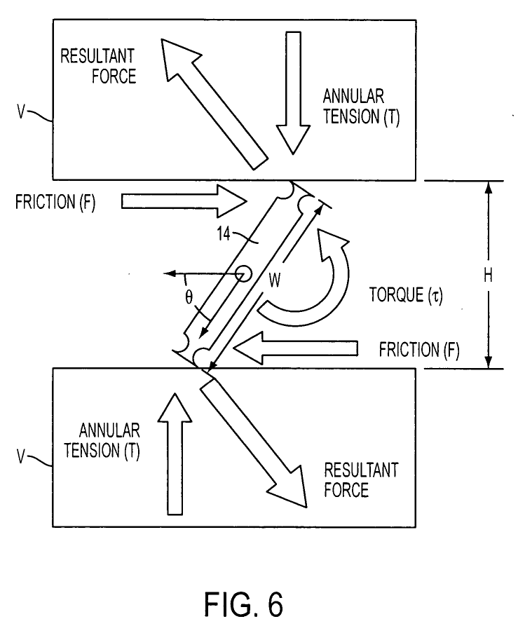

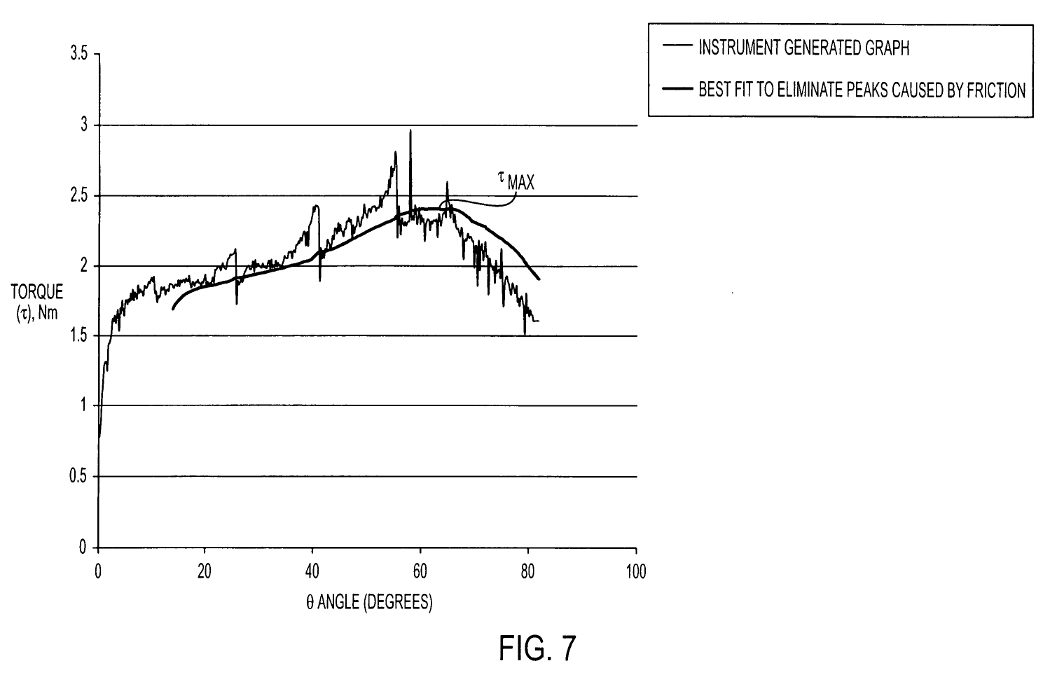

The torque signal output from the torque cell 6 and the angular rotation signal output from the rotary encoder 8 can be plotted, as shown in FIG. 7. (The plot of FIG. 7 is exemplary, based on laboratory tests, and does not necessarily accurately depict a torque versus angular rotation graph that would be generated using the tool between two vertebrae of an actual patient.) In addition, the annular tension between the two objects can be determined based on the torque and angular rotation measurements. As shown in FIG. 6, at any given point during the rotation of the implement, the torque (τ) applied to the working end 14 of the implement is equal to the frictional force (F) between the implement and the end plates of the vertebrae (V) multiplied by its moment arm (W sin θ), plus the annular tension (T) between the two vertebrae multiplied by its moment arm (W cos θ). In this equation, (W) is the width of the working end 14 of the implement, and (F) equals the coefficient of kinetic (μ) friction between the working end 14 and the vertebrae multiplied by the annular tension (T). (The coefficient of kinetic friction is a constant which can be measured ahead of time for each implement and its engagement with vertebrae.) This can be expressed as (equation 1): (τ)=(μT)(W sin θ)+(T)(W cos θ). Solving this equation for annular tension (equation 2): (T)=(τ)/(μ(W sin θ)+(W cos θ)). Thus, the annular tension (T) can be computed and plotted for any pair of (τ) and (θ) coordinates. Likewise, the displacement (H) between the two vertebrae can be calculated based on the width (W) of the working end 14 of the implement and the angle of rotation (θ). This can be expressed as (equation 3): (H)=(W sin θ).

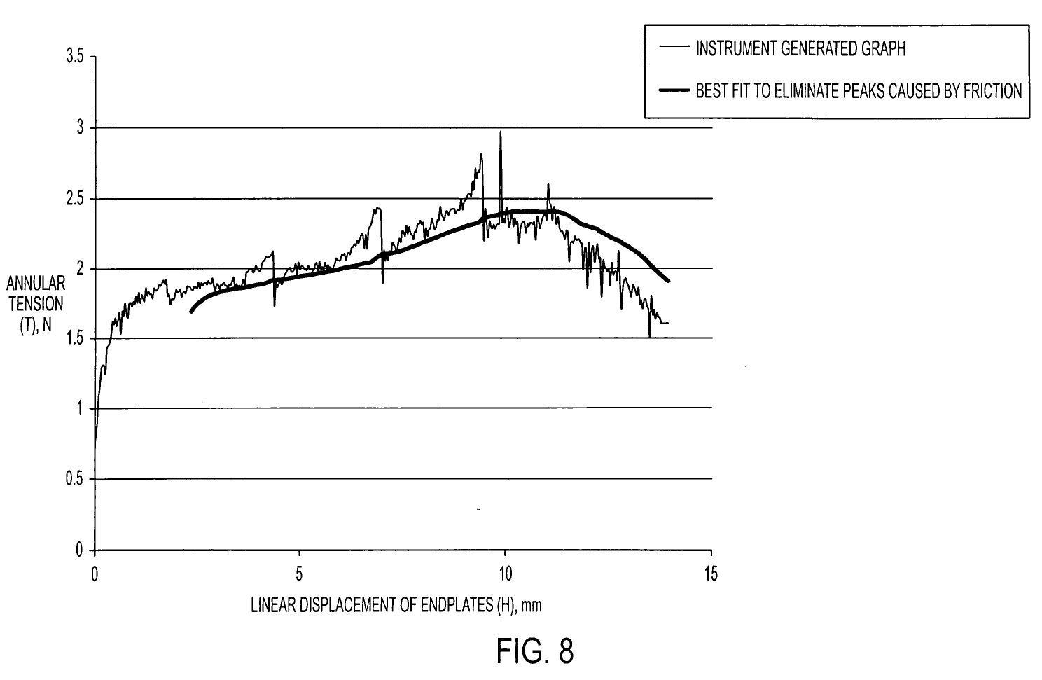

Thus, a plot of annular tension (T) versus displacement (H) can also be generated, as shown in FIG. 8. (The plot of FIG. 8 is exemplary, based on laboratory tests, and does not necessarily accurately depict a tension versus linear displacement graph that would be generated using the tool between two vertebrae of an actual patient.) While information about the torque, angular rotation, tension, and/or displacement is described as being displayed in graphical form, the information can alternatively be displayed in tabular form, or any other discernable manner. Alternatively, in some embodiments, the information need not be displayed at all.

It is envisioned that embodiments of the invention may be useful in numerous different surgical procedures. When performing various surgical procedures it is important to know the annular tension and spacing between two objects (or values, such as torque and angular rotation, which are indicative of the annular tension and spacing). For example, embodiments of the invention may be useful in performing spinal interbody fusion procedures, intervertebral disc replacement procedures, and other spinal procedures where the annular tension and/or spacing between vertebrae is measured. However, I envision that embodiments of the invention may also be used in other non-spinal surgical procedures, such as joint surgery, and the like.

In one specific example, a tool according to an embodiment of the invention can be used to determine what type of intervertebral cage to implant during a fusion procedure. First, the intervertebral disc space is accessed using a conventional procedure, such as an anterior (frontal) approach and/or posterior (rear) approach. Then, all or a portion of the natural intervertebral disc is removed, if necessary, using conventional discectomy and decompression procedures. A working end of the implement of the tool is then inserted in the intervertebral disc space between two adjacent vertebrae. Rotation of the implement distracts the vertebrae creating a space for insertion of the cage. After inserting the implement between the vertebrae, but before rotating the implement, the torque and angular rotation readings of the tool are preferably zeroed. Then, the implement is rotated, while measuring the torque and angular rotation of the implement.

Then, the surgeon or technician determines whether the annular tension is low enough that an expandable intervertebral cage will be able to properly expand in the intervertebral disc space. The annular tension will be said to be low enough if (i) the maximum torque measured by the tool is below a predetermined value of torque below which the expandable cage will fully deploy, (ii) the tension (derived from the torque as described above) is below a predetermined value of tension below which the expandable cage will properly deploy, and/or (iii) the coefficient of annular tension (κ) (which equals the slope of a plot of τ/θ over a period where r is increasing) is below a predetermined value below which the expandable cage will properly deploy. The predetermined values of torque, tension, and coefficient of annular tension below which the expandable cage will properly deploy will vary depending on the particular cage used, and can be determined experimentally prior to performing the surgical procedure based on a measured force required to compress the expandable intervertebral cage. Also, these predetermined values may be set to include a factor of safety, such that the predetermined values are set lower than the actual torque, tension, and/or coefficient of annular tension below which the cage will fully deploy.

If the tension is found to be low enough, the surgeon implants an expandable cage in the intervertebral disc space. If, however, the tension is found to be too high for the expandable cage to fully expand, the surgeon implants a standard, non-expandable cage in the intervertebral disc space.

In another specific example, a tool according to an embodiment of the invention can be used to determine what type of interbody fusion device to implant in an osteoperotic subsidence prevention procedure. The specifics of accessing and removing the natural intervertebral disc, inserting the implement of the tool and measuring the torque, tension, and/or coefficient of annular tension are substantially the same as for the intervertebral cage implant method described above and will not be described further herein.

In this method, the surgeon or technician determines whether the annular tension is high, such that osteoperotic vertebral end plates are likely to fail. The annular tension will be said to be high if (i) the torque measured by the tool exceeds a predetermined value of torque at which bone having a bone density comparable to the patient's will fail, (ii) the tension (derived from the torque as described above) exceeds a predetermined value of tension at which bone having a bone density comparable to the patient's will fail, and/or (iii) the coefficient of annular tension (κ) exceeds a predetermined value at which bone having a bone density comparable to the patient's will fail.

In practice, as the torque starts to approach the predetermined values of torque, tension, and/or coefficient of annular tension above which the patient's bone is likely to fail, the operator of the tool stops rotating the implement before the failure value is exceeded, so as to minimize the likelihood that the vertebral end plates will fail from the force of the implement.

The predetermined values of torque, tension, and/or coefficient of annular tension will be specific to each patient, and can be determined prior to surgery based on a measured bone density of the patient. Also, these predetermined values may be set to include a factor of safety, such that the predetermined values are set lower than the value at which bone failure is likely.

If the annular tension is determined to be high, such that bone failure is likely, the surgeon implants a soft fusion device, having a large surface area, to minimize the likelihood of osteoperotic bone failure. If on the other hand, the surgeon or technician determines in that the annular tension, and hence the risk of bone failure, is low, the surgeon implants a hard fusion device to maximize bone graft volume.

In another specific example, a tool according to an embodiment of the invention can be used to determine what type of intervertebral disc prosthesis to implant in a particular patient. There are generally three different classes of intervertebral disc prostheses on the market, constrained, semi-constrained, and unconstrained. The type of disc prosthesis that should be implanted in a particular patient depends on a number of factors, including the annular tension between the adjacent vertebrae. Generally, the higher the annular tension, the more unconstrained the disc prosthesis can be. Conversely, if the annular tension is loose, a constrained disc prosthesis should be used.

The specifics of accessing and removing the natural intervertebral disc, inserting the implement of the tool and measuring the torque, tension, and/or coefficient of annular tension are substantially the same as for the intervertebral cage implant method described above and will not be described further herein.

Based on the results of the torque, tension, and/or coefficient of annular tension measurements, the surgeon or technician determines whether the annular tension is high (unconstrained disc should be implanted), medium (semi-constrained disc should be implanted), or low (constrained disc should be implanted).

The annular tension will be said to high if (i) the torque measured by the tool exceeds a predetermined value of torque above which the intervertebral space is substantially stable, (ii) the tension (derived from the torque as described above) exceeds a predetermined value of tension above which the intervertebral space is substantially stable, and/or (iii) the coefficient of annular tension (κ) exceeds a predetermined value above which the intervertebral space is substantially stable.

The annular tension will be said to be low if (i) the torque measured by the tool is less than a predetermined value of torque below which the intervertebral space is substantially unstable, (ii) the tension (derived from the torque as described above) is less than a predetermined value of tension below which the intervertebral space is substantially unstable, and/or (iii) the coefficient of annular tension (κ) is less than a predetermined value below which the intervertebral space is substantially unstable.

The annular tension will be said to be medium if it is neither high nor low.

The predetermined values above and below which the intervertebral disc space is stable or unstable, respectively, can be determined empirically, based on the average annular tension Tₐᵥₑ of a statistically significant portion of the population, as adjusted for the specific patient, based on factors such as the age of the patient, the weight of the patient, whether or not the patient is a smoker, the preoperative height of the intervertebral disc space, and the like.

The details of methods of measuring torque, angular rotation, tension between two objects, and/or spacing between two objects are described below. The methods may, but need not necessarily, be performed using a tool according to one of the embodiments described herein. Alternatively, the method may be performed using a device that is now known or later developed.

The torque and angular rotation are measured using an implement, which is inserted between the two objects that are to be measured. First, a working end of the implement is inserted between the two objects. Then, the implement is rotated, such that the working end of the implement engages and presses against the two objects. A torque applied to the implement when the implement is rotated is measured using a torque measurement device. Also, an angular rotation of the implement is measured using an angular rotation measurement device. A torque signal, representative of the torque measured by the torque measurement device, and an angular rotation signal, representative of the angular rotation measured by the angular rotation measurement device are output, and may be displayed on a display unit. The signals may be displayed on the display unit as a graph of the torque measured by the torque measurement device versus the angular rotation measured by the angular rotation measurement device. A tension between the two objects and a linear displacement between the two objects may then be measured, based on the signals output from the torque measurement device and the angular rotation measurement device, and based on at least one dimension of the working end of the implement. In that case, in addition to or instead of information relating to torque and angular rotation, the display unit may display information representative of the annular tension versus the linear displacement.

Many of the foregoing conversions and method steps lend themselves to being carried out by or in connection with a computer (e.g., a personal computer, integrated display and conversion unit, microcontroller, processor, etc.), and can be programmed as code for performing the conversions and/or method steps and stored in computer readable format on media, such as random access memory, read only memory, a hard drive, a floppy disk, a CD-ROM, and the like. The code for implementing such conversions and/or methods would be readily apparent to one of ordinary skill in the art, in view of the foregoing description. When stored on such media, the code may be executed by one or more computers, with or without the aid of additional software such as an operating system.

The embodiments discussed herein are representative of exemplary embodiments of the invention and are provided for illustrative purposes only. Although specific structures, dimensions, components, etc., have been shown and described, such are not limiting. The various features, elements, and steps of the embodiments can be interchanged, rearranged, omitted, and/or combined in various different combinations to achieve a desired result.

What is claimed is:

1. A tool comprising:
a frame;
an implement having a longitudinal axis, a proximal end of said implement being coupled to said frame for rotation relative to said frame about the longitudinal axis of said implement, and a distal end of said implement comprising a working end of said implement and being adapted for insertion between two objects;
a driver coupled to said implement, wherein force can be applied by said driver to rotate said implement relative to said frame;
a torque measurement device coupled to said implement for measuring a torque on said implement when force is applied by said driver; and
an angular measurement device coupled to said implement to measure an angular rotation of said implement relative to said frame.

2. A tool according to claim 1, said torque measurement device comprising a torque cell, which measures the torque on said implement when force is applied by said driver and outputs a signal representative of the torque on said implement.

3. A tool according to claim 2, said torque cell being interposed between said implement and said driver and measures the torque between said implement and said driver.

4. A tool according to claim 1, said angular rotation measurement device comprising a rotary encoder, which measures an angular rotation of said implement relative to said frame and outputs a signal representative of the angular rotation of said implement relative to said frame.

5. A tool according to claim 1, said torque measurement device comprising a torque cell, which measures the torque on said implement when force is applied by said driver and outputs a signal representative of the torque on said implement, and said angular rotation measurement device comprising a rotary encoder, which measures an angular rotation of said implement relative to said frame and outputs a signal representative of the angular rotation of said implement relative to said frame.

6. A tool according to claim 5, further comprising a display unit, which receives the signals output from said torque cell and said rotary encoder, and displays information based on the signals received from said torque cell and said rotary encoder.

7. A tool according to claim 6, wherein the information displayed by said display unit comprises a graph of the torque measured by said torque cell versus the angular rotation measured by said rotary encoder.

8. A tool according to claim 6, further comprising a converter, which calculates a tension between the two objects and a linear displacement between the two objects, based on the signals received from said torque cell and said rotary encoder, and based on at least one dimension of the working end of said implement, wherein the information displayed by said display unit comprises information representative of the tension versus the linear displacement.

9. A tool according to claim 1, further comprising a handle protruding from said frame, by which a user can hold said tool during operation of said tool, said handle being separate from said driver.

10. A tool according to claim 1, further comprising a connector having a receptacle, said connector coupled to said frame for receiving and selectively coupling said implement to said frame, such that said implement is detachable from said frame.

11. A tool according to claim 1, said implement comprising one of a vertebral spreader, a shaver, and an artificial disc inserter.

12. A tool according to claim 1, wherein said tool is a surgical tool, and the working end of said implement is adapted to be inserted between two bones, such that when said implement is rotated, the two bones are spread apart.

13. A tool according to claim 1, wherein said driver comprises a lever, which can be rotated by a user to apply a torque to said implement.

14. A tool according to claim 1, further comprising:
a handle, separate from said driver, by which a user can hold said tool during operation of said tool;
a receptacle coupled to said frame for receiving and selectively coupling said implement to said frame, such that said implement is detachable from said frame,
wherein said implement comprises one of a vertebral spreader, a shaver, and an artificial disc inserter,
wherein said tool is a surgical tool, and the working end of said implement is adapted to be inserted between two bones, such that when said implement is rotated, the two bones are spread apart,
wherein said torque measurement device comprises a torque cell, which measures a torque generated when force is applied to said driver and outputs a signal representative of the torque generated by force applied to the driver, and
wherein said angular rotation measurement device comprises a rotary encoder, which measures an angular rotation of said implement relative to said frame and outputs a signal representative of the angular rotation of said implement relative to said frame.

15. A tool comprising:
a frame;
working means for inserting between two objects to engage the objects;
drive means coupled to said working means for rotating said working means relative to said frame;
torque measurement means coupled to said tool for measuring a torque on said working means when force is applied by said drive means; and
angular measurement means coupled to said working means to measure an angular rotation of said working means relative to said frame.

16. A tool according to claim 15, said torque measurement means being interposed between said working means and said drive means to measure the torque between said working means and said drive means.

17. A tool according to claim 15, further comprising display means for receiving signals from said torque measurement means and said angular rotation measurement means and displaying information based on the signals received from said torque measurement means and said angular rotation measurement means.

18. A tool according to claim 17, wherein the information displayed by said display means comprises a graph of the torque measured by said torque measurement means versus the angular rotation measured by said angular rotation measurement means.

19. A tool according to claim 17, further comprising converting means for calculating an annular tension between the two objects and a linear displacement between the two objects, based on the signals received from said torque measurement means and said angular rotation measurement means, and based on dimensions of said working means, wherein the information displayed by said display means comprises information representative of the annular tension versus to the linear displacement.

20. A tool according to claim 15, further comprising a handle protruding from said frame, by which a user can hold said tool during operation of said tool, said handle being separate from said drive means.

21. A method of measuring torque and angular rotation of an implement, the method comprising the steps of:
inserting a working end of the implement between two objects;
rotating the implement, such that the working end of the implement engages and presses against the two objects;
measuring a torque applied to the implement in said rotating step; and
measuring an angular rotation of the implement in said rotating step.

22. A method according to claim 21, further comprising the steps of:
outputting a torque signal representative of the torque measured in said torque measuring step; and
outputting an angular rotation signal representative of the angular rotation measured in said angular rotation measuring step.

23. A method according to claim 22, further comprising the step of displaying on a display unit a graph of the torque measured in said torque measurement step versus the angular rotation measured in said angular rotation measurement step.

24. A method according to claim 22, further comprising the steps of:
calculating a tension between the two objects and a linear displacement between the two objects, based on the signals output in said torque measurement step and said angular rotation measurement step, and based on at least one dimension of the working end of the implement; and
displaying on a display unit information representative of the annular tension versus the linear displacement.

25. A system comprising:
a tool that measures torque applied to, and angular rotation of, an implement of said tool placed between two objects, and that outputs signals representative of the torque and the angular rotation; and
a converter that receives the signals output from said tool, and outputs information about a tension between the two objects and a linear displacement between the two objects, based on the signals received from said tool and based on at least one dimension of a working end of said implement;
wherein the information displayed by said display unit comprises information representative of the tension versus the linear displacement.

26. A system according to claim 25, wherein said tool comprises:
a frame, a proximal end of said implement being coupled to said frame for rotation relative to said frame about a longitudinal axis of said implement, and a distal end of said implement comprising the working end of said implement and being adapted for insertion between the two objects;
a driver coupled to said implement, wherein force can be applied by said driver to rotate said implement relative to said frame;
a torque measurement device coupled to said implement for measuring a torque on said implement when force is applied by said driver; and
an angular measurement device coupled to said implement to measure an angular rotation of said implement relative to said frame.

27. A system according to claim 25, said system further comprising a display unit that displays the information output from said converter.

28. A system according to claim 25, wherein said converter comprises at least one of a computer, a data acquisition board, a processor, and an integrated conversion and display unit.

29. A system according to claim 25, wherein said converter comprises a medium, which stores code for converting the torque and angular rotation signals from said tool into tension and linear displacement values.
